(19) United States
(12) Patent Application Publication
(10) Pub. No.: US 2023/0405960 A1
(43) Pub. Date: Dec. 21, 2023

(54) FLUOROCHEMICAL-FREE MICROWAVE POPCORN PACKAGE AND PRODUCTION PROCESS

(71) Applicant: Conagra Foods RDM, Inc., Chicago, IL (US)

(72) Inventors: David W. France, Minneapolis, MN (US); John Garnett, IV, Chicago, IL (US); Jordan Dasher, Chicago, IL (US); Ryan O'Hern, Chicago, IL (US)

(21) Appl. No.: 18/206,880

(22) Filed: Jun. 7, 2023

Related U.S. Application Data
(60) Provisional application No. 63/350,258, filed on Jun. 8, 2022.

(51) Int. Cl. B31B 70/64; B32B 37/18; B32B 37/12; B32B 29/00; B65B 25/02; B32B 7/12; B31B 70/62

(52) U.S. Cl. CPC B31B 70/642; B32B 37/18; B32B 37/1284; B32B 29/005; B65B 25/02; B32B 7/12; B65D 81/3469; B32B 2317/12; B32B 2255/12; B32B 2439/46; B32B 2307/31; B32B 2250/02; B32B 2250/26; B31B 70/62

(57) ABSTRACT

A microwave popcorn package is described that includes unique combinations of low porosity paper, flexible adhesive with broad coverage, and narrowed seal configurations that combine together to address unique issues associated with interaction of the individual features.

### CROSS-REFERENCE TO RELATED APPLICATIONS

The present application claims the benefit under 35 U.S.C. § 119(e) of U.S. Provisional Application Ser. No. 63/350,258, entitled FLUOROCHEMICAL-FREE MICROWAVE POPCORN PACKAGE AND PRODUCTION PROCESS, filed Jun. 8, 2022. U.S. Provisional Application Ser. No. 63/350,258 is hereby incorporated by reference in its entirety.

### BACKGROUND

Microwave popcorn is a convenience food that consists of unpopped popcorn kernels in a sealed paper bag. The bag is intended to be heated in a microwave oven to pop the popcorn kernels.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner.

Aspects of the disclosure pertain to a microwave popcorn package formed substantially entirely of non-fluorocarbon material. In an aspect, a microwave popcorn package includes a flexible, wick resistant two-ply bag structure defining an expandable bag interior in which a charge of popcorn including unpopped popcorn kernels and at least one of an oil component or a fat component is positioned. The bag structure can be formed from low porosity paper to provide an inner ply of paper and an outer ply of paper laminated together with a low modulus adhesive. In an aspect, the adhesive is provided to the paper to substantially cover at least one of the exterior surface of the inner ply and the interior surface of the outer ply, which in combination with the low porosity paper, can provide a barrier against wicking by the oil/fat component (e.g., during storage of the microwave popcorn package and during microwave heating of the microwave popcorn package). The adhesive provides flowability and flexibility characteristics suitable to provide a full coverage layer to laminate the lower porosity inner ply and outer ply of paper, while reducing the effect of paper cracking or other physical deterioration of the paper which would otherwise pose a risk for wicking by the oil/fat component. Traditional higher modulus adhesives in full coverage layers would otherwise contribute to a higher modulus rollstock, which would increase the risk of rollstock cracking particularly during folding of the paper to create the microwave popcorn package structure. The adhesive also facilitates providing full coverage heat seal coating sections to interior surfaces of the inner ply used to form top, bottom, and longitudinal seals, where the physical characteristics of the low modulus adhesive are controlled to prevent substantial rollstock blocking that would otherwise inhibit commercial manufacturing of the microwave popcorn package.

The full coverage heat seal coating sections in combination with the low porosity paper further provide barriers against wicking by the oil/fat component at the interfaces of the rollstock used to form the top, bottom, and longitudinal seals. For example, the adhesive provides a lower heat seal initiation temperature than conventional adhesives, which facilitate sealing through multiple layers of paper (e.g., at end seals, gusset formation, etc.) while preventing oil penetration of the seals and while providing blister-formation resistance with the low porosity paper. One or more seals are formed in the bag structure using a narrowed seal jaw that provides a narrow seal between the low porosity paper and low modulus adhesive and that reduces the direct contact area between the seal jaw and the bag structure and the proximity between the non-contact body portions of the seal jaw and the bag structure to provide enough heat to seal the bag structure while preventing substantial blistering between the adhesive and the paper that can occur due to moisture flashing during the sealing process. Blistering can refer to the formation of bubbles, gaps, or voids in the seal area that fill with air which can damage the paper/seal interface. The adhesive is configured to have a low heat seal temperature to further reduce the amount of heat directed into the paper/adhesive during the sealing process to avoid flashing of the moisture in the low porosity paper, particularly where low porosity paper is less able to diffuse steam or other moisture as compared to higher porosity papers, such as those conventionally chemically treated with fluorocarbon materials. Since the microwave popcorn packages according to present disclosure include low porosity paper and substantially full adhesive coverage to laminate the two plies of the low porosity paper and to form heat seal coatings, conventional adhesives and seal jaws can provide a greater risk for blistering than for conventional microwave popcorn packages that utilize higher porosity papers, patterned adhesive applications, and/or thicker heat seals. Accordingly, in aspects, the microwave popcorn packages of the present disclosure utilize the low modulus adhesive with a narrowed seal formed by a specialized seal jaw to reduce the risk of blistering or other manufacturing defects that would otherwise promote wicking.

Microwave popcorn packages can include folded laminated paper tubes that include end seals (e.g., top and bottom seals) and longitudinal seals extending between the end seals to form the bag interior that holds the popcorn charge. The longitudinal seal can take several forms, such as a lap seal, where an end of an interior surface of the paper overlaps with an end of an exterior surface, a fin seal, where two end portions of the interior surface of the paper overlap with optional folding of the resulting fin, or the like. Generally, the longtitudinal seal of microwave popcorn packages can incur substantial contact with the charge of popcorn during storage and during the popping process, since the longitudinal seal can be formed along a longitudinal region extending between top and bottom seals of the microwave popcorn package. Blistering between the adhesive and the paper along the longitudinal seal can provide a point of failure of the microwave popcorn package that increases the likelihood of wicking across the contact region with the charge of popcorn. In an aspect, the microwave popcorn packages include a longitudinal seal having a narrow seal width formed using the narrowed seal jaw to prevent substantial blistering between the adhesive and the paper along the longitudinal region extending between top and bottom seals of the microwave popcorn package.

In an aspect, a method for forming a microwave popcorn package from substantially entirely non-fluorocarbon material includes providing a first ply and a second ply of a wick resistant two-ply bag structure. Each ply is formed from a low porosity paper to provide an initial resistance to wicking by the oil/fat component used in the charge of popcorn. The method also includes introducing at least one of the first ply or the second ply to an adhesive bath to coat substantially all of an exterior surface of at least one of the inner ply or the outer ply with adhesive. The adhesive is also introduced in a full coverage application to the inner ply (e.g. on an interior surface), the outer ply (e.g., on an exterior surface), or combinations thereof, in a plurality of heat seal coating regions that occupy a portion of the total surface area. The positioning of the adhesive at the heat seal coating regions facilitates formation of a top seal, a bottom seal, a longitudinal seal between the top seal and the bottom seal, one or more gussets, or the like, to form the microwave popcorn package structure. The adhesive is a low modulus adhesive configured to bond to the low porosity paper and includes a low heat seal temperature to reduce the amount of heat needed to seal portions of the bag structure. In some aspects, the adhesive or the adhesive bath includes an anti-foaming agent to prevent gases from being entrained in the adhesive during application to the paper, where entrained gases can form voids that reduce resistance to wicking of the oil/fat component by the paper and adhesive.

The method also includes laminating the first ply and the second ply together and forming a seal in the bag structure to define an expandable bag interior. The seal can be formed by a narrowed seal jaw that provides a narrow seal between the low porosity paper and flexible adhesive and that reduces the direct contact area between the seal jaw and the bag structure to provide enough heat to seal the bag structure while preventing substantial blistering between the adhesive and the paper that can occur due to moisture flashing during the sealing process. The adhesive is configured to have a low heat seal temperature to further reduce the amount of heat directed into the paper/adhesive during the sealing process to avoid flashing of the moisture.

### DRAWINGS

The detailed description is described with reference to the accompanying figures.

FIG. 1 is a front perspective view of a microwave popcorn package sealed in a storage overwrap in accordance with example implementations of the present disclosure.

FIG. 2 is a schematic top plan view of the microwave popcorn package of FIG. 1, depicted unwrapped and unfolded as it would be when positioned in a microwave oven for cooking.

FIG. 3 is a cross-sectional view of the microwave popcorn package of FIG. 2, taken generally along line 3-3 of FIG. 2.

FIG. 4 is an exploded isometric illustration of a rollstock construction for forming a microwave popcorn package upon a sealing process in accordance with example implementations of the present disclosure.

FIG. 5 is an isometric view of a formed microwave popcorn package in accordance with example implementations of the present disclosure.

FIG. 6 is a flow diagram illustrating a method for producing a microwave popcorn package in accordance with example implementations of the present disclosure.

FIG. 7A is an isometric view of a heat seal jaw in accordance with example implementations of the present disclosure.

FIG. 7B is an end view of the heat seal jaw of FIG. 7A.

FIG. 7C is a partial side view of the heat seal jaw of FIG. 7A.

### DETAILED DESCRIPTION

Features of the detailed description can be embodied in many different forms and should not be construed as limited to the combinations set forth herein; rather, these combinations are provided so that this disclosure will be thorough and complete, and will fully convey the scope. Among other things, the features of the disclosure can be embodied as food packages, microwave popcorn packages, and processes for forming microwave popcorn packages. The following detailed description is, therefore, not to be taken in a limiting sense.

Microwave popcorn packages are available in various configurations and compositions and generally include a charge of unpopped popcorn held in a package suitable for heating within a microwave oven. During use, the microwave popcorn package is introduced to a microwave oven where the unpopped popcorn is subjected to microwave energy, resulting in a buildup of steam within the popcorn hull. As the pressure within the popcorn kernel rises, the popcorn hull ruptures and produces a fluffy popped corn. Microwave popcorn packages can include an oil component, a fat component, or combinations thereof. For example, an oil/fat component can be included to impart a particular flavor profile, such as to facilitate covering of the popped popcorn with an included seasoning, to facilitate even popping of the kernels (e.g., in combination with an optionally included microwave susceptor material in the microwave popcorn package), for nutritive or mouthfeel considerations, or the like.

During production, storage, distribution and handling of microwave popcorn packages, the oil/fat component held in the microwave popcorn package can undesirably migrate within the bag and wick from the bag, such as if the oil/fat component contains a liquid or becomes liquid prior to preparing in the microwave oven (e.g., stored in a warm environment, introduced to the microwave popcorn package as a liquid during production, etc.). During the microwave popping operation, the oil/fat component totally melts and flows. Flow of liquid oil/fat within the bag can result in leakage or leaking problems. For example, the oil/fat can begin to wick through the bag, especially at locations where fractures in the paper may be present. Such fractures can occur at folds along paper used to form the microwave popcorn package, along interfaces of the paper with stiff adhesive, or the like. Also, the oil/fat can migrate to seams or seals, for example, to a seam near an end of the package or along a longitudinal portion of the package, and leak through the seam. Such leakage or wicking can compromise the microwave popping operation, provide a poor package appearance or texture to consumers, alter the flavor profile of the popcorn, or the like.

Microwave popcorn packages can include several defining characteristics. First, the packages are generally provided in a configuration wherein side gussets are used to separate the internal volume of the bag into first and second “tubes.” When the bag is filled, generally the popcorn charge is placed in one of the two “tubes” and is substantially retained therein, prior to popping. Also, in general, the popcorn charge is positioned primarily in a center portion (e.g., about a center one-third) of the package, relative to its length. In many arrangements, during storage the bag is folded into a “tri-fold” configuration. In implementations, the package can include a “bi-fold” configuration with the popcorn charge positioned primarily on one of two sides of the package, relative to its length. In some instances, it has been found that positioning the popcorn charge substantially only in one of the two tubes, especially in association with a microwave interactive material or susceptor positioned in close proximity, leads to enhanced characteristics of popping. As used herein, when it is said that the popcorn charge is “substantially only” in a location, it is meant that at least 80%, at least 95 wt-%, or essentially all (e.g., at least 99% by weight) of the charge (popcorn, fat, flavor, etc.), is at the stated location.

While the folded characteristics can provide benefits to popping and storage characteristics (e.g., a compact storage area as compared to bi-fold or no-fold popcorn packages), the folds can crease the paper of the package. Creasing of paper generally results in micro fracture of the paper integrity at the edge of creasing. With some arrangements, if the popcorn charge is allowed to come into direct contact with a creased location, several problems can occur. First, during production, distribution and storage, depending on the content of the microwave popcorn charge, undesirable levels of leakage or wicking of oil/fat material through the paper material at the creased edges can occur. Secondly, during microwave popping, undesirable levels of leakage or wicking of oil/fat can occur along this same creased location. Additionally, the porosity of the paper can affect leakage or wicking of oil/fat, where porous paper provides low resistance to oil passage.

Popcorn packaging can be mechanically refined to reduce leakage or wicking of oil/fat. For example, starches can be added to the paper of the packaging to decrease permeability. However, the addition of starches also increases the stiffness of the paper, which makes the paper more likely to crack. Chemically-treated paper can also be utilized to reduce leakage and/or wicking of oil/fat. For example, a chemical surface treatment can be applied to the paper to provide grease resistance, such as through use of a fluorochemical-treated paper. However, fluorochemical additives can have negative associations with environmental conditions and health/well-being of consumers.

A microwave popcorn package is described that includes unique combinations of low porosity paper, flexible adhesive with broad coverage, heat seal coatings with low seal initiation temperatures, and narrowed seal configurations that combine together to address unique issues associated with interaction of the individual features. The low porosity paper provides a mechanical barrier to leakage or wicking of oil/fat. In various aspects, the low porosity paper is not chemically treated with a fluorochemical additive, although a starch component can be included to further reduce porosity, assist with fiber binding, or the like. While the low porosity paper provides a mechanical barrier to leakage or wicking, the paper can show resistance to surface binding with certain qualities of adhesives, particularly high modulus adhesives that have relatively high glass transition temperatures or heat seal temperatures. The microwave popcorn packages described herein include a low modulus adhesive that bonds to the low porosity papers, resists cracking associated with folding of the paper into the expandable bag configuration, resists leakage or wicking of oil/fat through broad coverage of the flexible adhesive to interior surfaces exposed to the charge of unpopped popcorn, and provides suitable blocking characteristics to promote unwinding of a rollstock of the combined low porosity paper and adhesive. The low seal initiation temperatures of the flexible adhesives used herein facilitate commercial scale production of the microwave popcorn without substantial blistering of the paper/adhesive interface, where such blistering is more commonly experienced at higher seal temperatures.

In various aspects, the microwave popcorn packages described herein are formed using a heat seal jaw that imparts pressure and heat to portions of the paper to promote heal sealing of the flexible adhesive and low porosity paper while preventing substantial blistering between the paper and the adhesive. Blistering between the adhesive and the paper along the longitudinal seal can provide a point of failure of the microwave popcorn package that increases the likelihood of wicking across the contact region with the charge of popcorn. In particular, blisters having a size of about one-fourth inch or greater provide a gap or void between the paper and the adhesive that separates or damages the paper/seal interface and provides a pathway for undesirable amounts of wicking. In aspects, the microwave popcorn packages described herein include full coverage of the flexible adhesive between two low porosity paper plies and for heat seal coatings to facilitate barriers to wicking, but that could pose a risk to blister formation for conventional seal formation techniques that typically utilize higher porosity papers with chemically-treated surfaces and patterned (i.e., not full) adhesive coverage that provide for faster moisture diffusion during heat application. The heat seal jaw described herein can have a narrower width and a steeper angled taper than traditional jaw designs to provide sufficient seal strength to maintain the integrity of the collapsible bag seals during the microwave popping operation. The heat seal jaw also keeps non-seal edge portions of the heat seal jaw away from the paper and adhesive, which, in combination with the lower heat seal temperatures of the flexible adhesive, avoid substantial moisture flashing that could introduce bubbles or voids in the adhesive.

Aspects of the disclosure pertaining to microwave popcorn packages are provided below. While particular examples herein are directed to microwave popcorn packages including a charge of unpopped popcorn and at least one of an oil component or a fat component positioned within the bag interior, it is noted that other or additional ingredients can be utilized to produce similar microwave popcorn packages generally described herein, including but not limited to, seasoning(s), flavoring(s), stabilizer(s), colorant(s), and the like.

### I. Components of the Microwave Popcorn Package

The microwave popcorn package includes several components combined together to address unique issues associated with interaction of the individual features. In general, these components include low porosity paper, low modulus adhesive present in full coverage applications for paper lamination and seal formation, and narrowed seals that interact together to provide a barrier to leakage or wicking of oil/fat present in the charge of unpopped popcorn held within the collapsible bag. Additionally, these components facilitate commercial production of the microwave popcorn packages by providing paper rollstocks that avoid substantially blocking despite the amount of adhesive used to form the heat seal coatings on the low porosity paper, while still permitting heat seal formation without substantial blistering between the paper and adhesive. The paper, adhesive, and seals are configured to interact with each other to address the specific characteristics of the other components to provide a microwave popcorn package that provides resistance to leakage or wicking of oil/fat components without fluoropolymer treatment while forming an expandable bag that includes seals that avoid substantial blistering between the paper and adhesive. For instance, a fluorocarbon-free paper is generally more brittle and has a lower tear resistance than a fluorocarbon-treated paper, while providing less wick resistance than a fluorocarbon-treated paper. Refining a fluorocarbon-free paper to provide low porosity can assist with wick resistance, but also causes the paper to become brittle. Attempting to transition to a fluorocarbon-free, low porosity paper to assist with wicking resistance showcased the issues with traditional adhesives, which are generally high modulus. When a high modulus adhesive is deposited onto fluorocarbon-free paper in a full coverage application, the overall rollstock is brittle, providing undesirable wicking resistance due to cracking of the paper during microwave popcorn package formulation (e.g., during which the paper is folded, bent, or otherwise manipulated). Moreover, a low porosity paper, while providing better wicking resistance than high porosity paper, has a higher tendency to form blisters between the paper and adhesive due to less ability to vent flashing of moisture during heat seal formation.

The low modulus adhesive described herein can be utilized for lamination of the paper used in the rollstock and can be provided in a full coverage application layer between the inner and outer plies to facilitate with wick resistance from the inner layer to the outer layer. The adhesive can also be included in heat seal coating regions on the rollstock in full coverage applications to form the longitudinal seal, the top seal, and the bottom seal of the microwave popcorn package to facilitate with wick resistance through the seals. While a low seal initiation temperature for an adhesive generally improves blistering characteristics (e.g., by reducing the tendency to form blisters), the low seal initiation temperature can increase the likelihood that the commercial production experiences rollstock blocking, such as due to the location of the heat seal coatings on the interior surface of the inner ply of the paper in the rollstock. The flexible adhesives described herein have been found to provide both low blocking concern and low blistering concern, even where full coverage adhesive applications are used with low porosity paper.

### A. Paper

In general, the paper used in the construction of the microwave popcorn package is a low porosity paper providing a mechanical barrier to leakage or wicking of oil/fat. In various aspects, the microwave popcorn package includes a two-ply paper construction formed into an expandable bag structure with an interior holding the unpopped charge of popcorn. The two-ply paper construction generally includes an inner ply of paper facing an interior of the bag structure (e.g., interfacing with the unpopped popcorn charge) and an outer ply of paper facing outwards from the bag structure. If the porosity of the paper is too high, then the paper tends to provide low resistance to oil/fat leakage or wicking, which can be undesirable to consumers. However, while low porosity paper provides higher resistance to oil/fat leakage or wicking, the low porosity poses challenges for microwave popcorn bag construction due to risks of paper cracking, moisture flashing during seal formation, and the like described herein. Use of the low modulus adhesive having a low heat seal initiation temperature in combination with a narrowed heat seal jaw used to form at least the longitudinal seal of the microwave popcorn package has shown to mitigate these challenges and provide desirable levels of wick resistance without substantial amounts of fluorocarbon materials. The inner ply and the outer ply can be formed from various paper types. For example, the inner ply and the outer ply can be formed from the same paper type having the same porosity. As another example, the inner ply and the outer ply can be formed from different paper types having different porosity. As another example, the inner ply and the outer ply can be formed from different paper types having substantially similar porosity.

In various aspects, the inner ply is made from a paper having a porosity (Gurley-sec) of at least 50,000. For example, in specific embodiments, the inner ply is made from a paper having a porosity (Gurley-sec) of at least 50,000, at least 75,000, at least 100,000, at least 200,000, at least 350,000 at least 500,000, at least 700,000, at least 900,000, at least 1,000,000, at least 1,500,000, at least 2,000,000, at least 2,500,000, at least 3,000,000, at least 3,500,000, at least 4,000,000, at least 4,500,000, or at least 5,000,000, where higher Gurley-sec figures indicate lower porosity.

The outer ply can be formed from a paper having the same porosity as the inner ply or having a different porosity than the inner ply. In various aspects, the outer ply is made from a paper having a porosity (Gurley-sec) of at least 50,000. For example, in specific embodiments, the outer ply is made from a paper having a porosity (Gurley-sec) of at least 50,000, at least 75,000, at least 100,000, at least 150,000, at least 200,000, at least 300,000, at least 400,000, at least 500,000, at least 750,000, at least 900,000, or at least 1,000,000, where higher Gurley-sec figures indicate lower porosity. In aspects, the outer ply is made from a paper having a porosity (Gurley-sec) of at least 50,000, at least 75,000, at least 100,000, at least 200,000, at least 350,000 at least 500,000, at least 700,000, at least 900,000, at least 1,000,000, at least 1,500,000, at least 2,000,000, at least 2,500,000, at least 3,000,000, at least 3,500,000, at least 4,000,000, at least 4,500,000, or at least 5,000,000. Since the outer ply does not face the unpopped charge of popcorn, the outer ply typically does not interact with the oil/fat component to the same extent as the inner ply and thus can be formed from a paper having a higher porosity than the inner ply.

In some embodiments, the paper used to form the inner ply and the outer ply is a material containing substantially no fluorocarbon (e.g., a non-fluorocarbon treated paper). The material can include fluorocarbon in a weight percentage of total content of the paper from about 0% to about 1%. For example, the weight percentage of the fluorocarbon in the paper can be from about 0.0%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0% to about 0.0%, 0.01%, 0.02%, 0.03%, 0.04%, 0.5%, 0.06%, 0.07%, 0.08%, 0.09%, 0.1%, 0.2%, 0.3%, 0.4%, 0.5%, 0.6%, 0.7%, 0.8%, 0.9%, 1.0%. Although alternatives are possible, the arrangements described herein can be formed from a bag arrangement made of two plies of non-fluorocarbon treated paper. In example embodiments, the paper used to form the inner ply and the outer ply is a material containing no more than 0.01% fluorocarbon material by weight percentage of total content of the paper (i.e., no more than 100 ppm fluorocarbon material).

The paper can include moisture present from the process of forming the low porosity paper. In various aspects, the paper includes a moisture content from about 3% to about 8% on a weight basis of the total weight of the paper. For example, the moisture content can be from about 3.0%, 3.5%, 4.0%, 4.5%, 5.0%, 5.5%, 6.0%, 6.5%, 7.0%, 7.5%, 8.0% to about 3.0%, 3.5%, 4.0%, 4.5%, 5.0%, 5.5%, 6.0%, 6.5%, 7.0%, 7.5%, 8.0% on a weight basis of the total weight of the paper. In an aspect, the moisture content is from about 4.5%, 5.0%, 5.5%, 6.0%, 6.5% to about 4.5%, 5.0%, 5.5%, 6.0%, 6.5% on a weight basis of the total weight of the paper. The moisture content of the paper can provide a risk for flashing off of steam during the heat seal process, particularly due to the low porosity of the paper (e.g., each ply of paper having a porosity of at least 50,000 Gurley-sec). The moisture flash can create bubbles or voids between the adhesive and the paper as the steam is formed from the temperature of the heat seals, forming regions having lower resistance to oil/fat leakage or wicking. As described further herein, one or more seals formed in the microwave popcorn package can have a narrower width than conventional microwave popcorn package seals and are formed from a heat seal jaw having a steeper angled taper than traditional jaw designs to provide sufficient seal strength with the flexible adhesive to maintain the integrity of the collapsible bag seals during the microwave popping operation while avoiding substantial moisture flashing that could introduce bubbles or voids in the adhesive.

In various aspects, the low porosity paper includes a fibrulated fiber structure having roughed fibers configured to interlock with each other. Such fibrulated fiber structure can provide the low porosity structure to facilitate the mechanical barrier to oil/fat leakage and wicking and can support adhesion of the adhesive to the paper structure. Alternatively or additionally, the low porosity paper can include a starch component, such as a starch coating, to further reduce porosity, assist with fiber binding, or the like.

### B. Adhesive

In general, the adhesive used in the microwave popcorn package is a flexible adhesive configured to adhere to the low porosity paper (e.g., to provide lamination of the two plies of paper), to seal one end of the two-ply bag structure to another end of the two-ply bag structure (e.g., to facilitate a longitudinal seal, such as a lap seal, a fin seal, or the like), to provide a mechanical barrier to leakage or wicking of oil/fat, to maintain a flexible state when subjected to folding (e.g., to provide a tri-fold bag structure), and to form a heat seal with the low porosity paper without substantial blistering between the adhesive and the paper. The adhesive maintains a low modulus state during manufacture of the microwave popcorn package and during storage of the microwave popcorn package, while maintaining integrity during the microwave popping operation to provide a mechanical barrier to the oil/fat component. Additionally, the adhesive is configured to provide suitable blocking characteristics to promote unwinding of a rollstock of the combined low porosity paper and adhesive, even with full coverage heat seal coatings applied to the low porosity paper. Such properties facilitate commercial throughput of microwave popcorn packages, where conventional adhesives, papers, and seal configurations hinder one or more aspects of commercial production (e.g., production stoppage to clear rollstock blockages, faulty products due to undesirable amounts of blistering, etc.).

Certain aspects of microwave popcorn packages that utilize traditional high modulus adhesives and patterned adhesive application (e.g., for lamination) are problematic for aspects of the microwave popcorn products described herein. For instance, while traditional microwave popcorn packages utilize patterned application of adhesives with fluorocarbon-treated paper, the pattern-applied adhesives are not continuous layers, but rather provide gaps in coverage, where the adhesive contributes less to the overall structure modulus of the rollstock, allowing higher modulus adhesives to be utilized. The patterned adhesive applications are suitable for such conventional applications due in part to usage of the fluorocarbon-treated paper to provide grease resistance. In aspects, microwave popcorn products described herein utilize full adhesive coverage for the lamination adhesive and for heat seal coatings on low porosity, non-fluorocarbon treated paper. When full coverage adhesive is utilized, the contribution to the overall structure modulus is more significant than patterned adhesive modulus contribution, so lower modulus adhesives are utilized for the full coverage applications. However, low modulus adhesive can contribute more to rollstock blocking than higher modulus adhesive, particularly where the adhesive is present in full coverage applications at the heat seal regions as compared to patterned applications.

The low modulus adhesives described herein showcase anti-blocking behavior suitable for commercial scale rollstock while maintaining a low modulus to avoid cracking of the paper during production. Experiments with attempting to combine the low porosity paper with traditional high modulus adhesives in full coverage applications resulted in flex cracking during processing of the rollstock to form microwave popcorn package structures that reduced the mechanical barrier to the oil/fat component. Additionally, full coverage application of traditional adhesives relied on high heat requirements during the heat seal process resulting in moisture flashing and blistering of the low porosity paper and adhesive, among other issues. Moreover, patterned adhesive coverage provided less wicking protection at regions of the paper that were not covered by the adhesive, where only the low porosity paper characteristics were present to resist the passage of oils and fats. Historically these uncovered regions were protected through usage of a fluorocarbon-treated paper and thus posed less of a wicking concern. Experiments with removal of the fluorocarbon-treated paper showed that patterned adhesive coverage provided undesirable amounts of wicking, even with usage of the low porosity paper. Example traditional adhesives were stiff when cured, having a modulus from about 1.3 MPa to about 1.7 MPa and included a viscosity of greater than 1400 cps and a heat seal temperature of about 280° F. or greater when subjected to a serrated heat seal jaw having a seal pressure of approximately 70 psi with a dwell time of approximately 0.5 secs.

The adhesive used in the microwave popcorn package can have a lower heat seal temperature than traditional adhesives used in microwave popcorn packages and showcased more flexible properties when cured, having a modulus from about 0.51 MPa to about 0.9 MPa. The heat seal temperature used for microwave popcorn packages according to the present disclosure can depend on the location of the seal for the microwave popcorn package. For instance, top and bottom seals can be formed with higher temperatures during the sealing procedure than for longitudinal seals since the seal jaws used to form the top and bottom seals can interact with the paper at a reduced dwell time as compared to the longitudinal seal. In various aspects, the adhesive used in the microwave popcorn package has a heat seal temperature for the longitudinal seal from about 190° F. to about 270° F. when subjected to a serrated heat seal jaw having a seal pressure of approximately 70 psi with a dwell time of approximately 0.5 secs. For example, the adhesive can have a heat seal temperature from about 190° F., 195° F., 200° F., 205° F., 210° F., 215° F., 220° F., 225° F., 230° F., 235° F., 240° F., 245° F., 250° F., 255° F., 260° F., 265° F., 270° F. to about 190° F., 195° F., 200° F., 205° F., 210° F., 215° F., 220° F., 225° F., 230° F., 235° F., 240° F., 245° F., 250° F., 255° F., 260° F., 265° F., 270° F. when subjected to a serrated heat seal jaw having a seal pressure of approximately 70 psi with a dwell time of approximately 0.5 secs. In an example implementation, the adhesive can have a heat seal temperature from about 200° F. to about 265° F. For example, the adhesive can have a heat seal temperature for the longitudinal seal from about 235° F. to about 265° F. In implementations, the top seal and the bottom seal can have a heat seal temperature that exceeds the heat seal temperature for the longitudinal seal, for example, from about 285° F. to about 305° F. for the top seal and the bottom seal.

In various aspects, the adhesive has a viscosity of less than 1300 cps at 79° F. with a total solids content of about 52.5% and a modulus from about 0.5 MPa to about 0.9 MPa to provide a substantially flexible adhesive suitable for laminating the two plies of low porosity paper while providing a relatively low heat seal temperature (e.g., such as a heat seal temperature of less than about 270° F.). In an aspect, the adhesive can have a viscosity at 79° F. from about 900 cps to about 1350 cps. For example, the adhesive can have a viscosity at 79° F. from about 900 cps, 950 cps, 1000 cps, 1050 cps, 1100 cps, 1150 cps, 1200 cps, 1250 cps, 1300 cps, 1350 cps to about 900 cps, 950 cps, 1000 cps, 1050 cps, 1100 cps, 1150 cps, 1200 cps, 1250 cps, 1300 cps, 1350 cps. In laboratory experimental analysis performed at 79° F., a sample of the adhesive showcased a viscosity from about 1250 cps to about 1300 cps with a total solids content of about 52.5%. Dilution of the sample with water showcased a viscosity from about 600 cps to about 50 cps when diluted with water to a total solids content from about 52% to about 40%.

The adhesive can include an anti-foaming agent to prevent foaming during transfer from an adhesive bath to the low porosity paper. For example, the adhesive can be transferred to the low porosity paper via a rotating cylinder, where cells on the cylinder surface can carry air into the adhesive bath. During prolonged operation, the rotating cylinder can cause foam to form in various adhesive baths, such as adhesive baths without an antifoaming agent, which can form voids in the adhesive applied to the low porosity paper. Such voids can reduce resistance to wicking of the oil/fat component by the paper and adhesive. The anti-foaming agent can include, but is not limited to, a silica, a polyglycol, a wax, polydimethylsiloxane (PDMS), or the like, or combinations thereof.

### C. Heat Seal

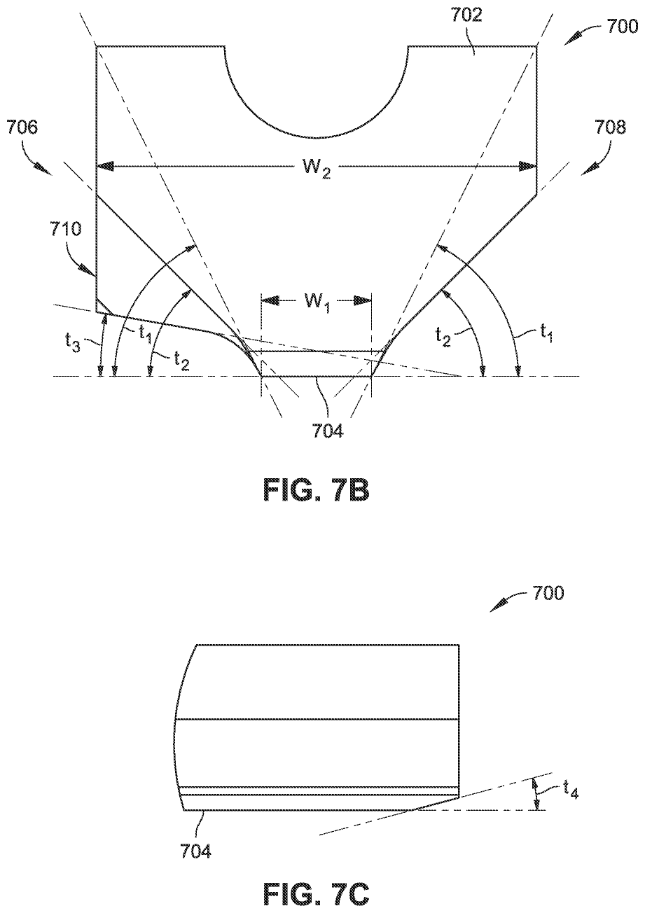

The microwave popcorn package includes a narrowed heat seal formed as a longitudinal seal through application of pressure and heat to portions of the paper to promote heal sealing of the flexible adhesive and low porosity paper while preventing substantial blistering between the paper and the adhesive. In various aspects, the heat seal is formed through application of a heat seal jaw to overlapped portions of the two-ply paper with the flexible adhesive therebetween. An example heat seal jaw for providing the longitudinal seal is described further herein with respect to FIGS. 7A through 7C.

In various aspects, the heat seal jaw used to form the longitudinal seal has a width (e.g., shown as w₁ in FIG. 7B) from about 0.30 in to about 0.45 in to promote heal sealing of the flexible adhesive and low porosity paper while preventing substantial blistering between the paper and the adhesive. For example, the heat seal jaw can have a width from about 0.30 in, 0.31 in, 0.33 in, 0.34 in, 0.35 in, 0.36 in, 0.37 in, 0.38 in, 0.39 in, 0.40 in, 0.41 in, 0.42 in, 0.43 in, 0.44 in, 0.45 in to about 0.30 in, 0.31 in, 0.32 in, 0.33 in, 0.34 in, 0.35 in, 0.36 in, 0.37 in, 0.38 in, 0.39 in, 0.40 in, 0.41 in, 0.42 in, 0.43 in, 0.44 in, 0.45 in. Heat seal jaws used to form the top and bottom seals can have a greater width than the heat seal jaw used to form the longitudinal seal, since the top and bottom seals can be formed through more layers of material (e.g., four plies based on gusset folds) than the longitudinal seal (e.g., typically two plies). The top and bottom seals can have a wider and more pronounced seal profile to ensure that no channels remain between the many layers of paper material and the exterior of the bag. For example, the heat jaws used to form the top and bottoms seals can be a width of about 0.50 in or greater. In implementations, the heat seal jaws used to form the top and bottom seals are formed from a straight-cut steel material to minimize blistering impact on the bag at the top and bottom seals, whereas the thin profile of the heat seal edge of the heat seal jaw used for the longitudinal seal can prevent utilization of a straight-cut steel material (examples of the heat seal jaw used for the longitudinal seal are described further herein with respect to FIGS. 7A through 7C).

The heat seal jaw used to form the longitudinal seal can include one or more angled tapers to keep non-seal edge portions of the heat seal jaw away from the paper and adhesive to avoid substantial moisture flashing that could introduce bubbles or voids in the adhesive. In various aspects, the heat seal jaw includes a taper from about 50 degrees to about 70 degrees from the horizontal extending in each direction from the width of the heat seal jaw (e.g., shown as t₁ in FIG. 7B) to draw the non-seal edge portions away from the contact surface between the heat seal jaw and the low porosity paper and flexible adhesive combination. For example, the heat seal jaw can include a taper from the width of the heat seal jaw from about 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees to about 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees.

One or more sides of the width of the heat seal jaw used to form the longitudinal seal can transition from an initial taper to a shallower taper. For example, in an aspect, the heat seal jaw includes a first taper from about 50 degrees to about 70 degrees (e.g., shown as t₁ in FIG. 7B) that transitions to a second taper from about 40 degrees to about 50 degrees when moving vertically up the heat seal jaw (e.g., shown as t₂ in FIG. 7B). For example, the first taper can be from about 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees to about 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees and the second taper can be from about 40 degrees, 41 degrees, 42 degrees, 43 degrees, 44 degrees, 45 degrees, 46 degrees, 47 degrees, 48 degrees, 49 degrees, 50 degrees to about 40 degrees, 41 degrees, 42 degrees, 43 degrees, 44 degrees, 45 degrees, 46 degrees, 47 degrees, 48 degrees, 49 degrees, 50 degrees.

In an aspect, the heat seal jaw includes one side that transitions from a first taper from about 50 degrees to about 70 degrees (e.g., shown as t₁ in FIG. 7B) to a second taper from about 30 degrees to about 50 degrees when moving vertically up the heat seal jaw (e.g., shown as t₂ in FIG. 7B) and an opposing side that transitions from a first taper from about 50 degrees to about 70 degrees (e.g., shown as t₁ in FIG. 7B) to a second taper from about 5 degrees to about 25 degrees when moving vertically up the heat seal jaw (e.g., shown as t₃ in FIG. 7B). For example, the first taper of the first side can be from about 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees to about 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees and the second taper of the first side can be from about 30 degrees, 31 degrees, 32 degrees, 33 degrees, 34 degrees, 35 degrees, 36 degrees, 37 degrees, 38 degrees, 39 degrees, 40 degrees, 41 degrees, 42 degrees, 43 degrees, 44 degrees, 45 degrees, 46 degrees, 47 degrees, 48 degrees, 49 degrees, 50 degrees to about 30 degrees, 31 degrees, 32 degrees, 33 degrees, 34 degrees, 35 degrees, 36 degrees, 37 degrees, 38 degrees, 39 degrees, 40 degrees, 41 degrees, 42 degrees, 43 degrees, 44 degrees, 45 degrees, 46 degrees, 47 degrees, 48 degrees, 49 degrees, 50 degrees and the first taper of the opposing side can be from about 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees to about 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees with the second taper of the opposing side being from about 5 degrees, 6 degrees, 7 degrees, 8 degrees, 9 degrees, 10 degrees, 11 degrees, 12 degrees, 13 degrees, 14 degrees, 15 degrees, 16 degrees, 17 degrees, 18 degrees, 19 degrees, 20 degrees, 21 degrees, 22 degrees, 23 degrees, 24 degrees, 25 degrees to about 5 degrees, 6 degrees, 7 degrees, 8 degrees, 9 degrees, 10 degrees, 11 degrees, 12 degrees, 13 degrees, 14 degrees, 15 degrees, 16 degrees, 17 degrees, 18 degrees, 19 degrees, 20 degrees, 21 degrees, 22 degrees, 23 degrees, 24 degrees, 25 degrees.

In various aspects, the heat seal jaw used to form the longitudinal seal includes an end taper from the longitudinal direction of the heat seal jaw to keep non-seal edge portions of the heat seal jaw away from the paper and adhesive to avoid substantial moisture flashing that could introduce bubbles or voids in the adhesive. The end taper can be from about 5 degrees to about 40 degrees from the horizontal extending in the longitudinal direction of the heat seal jaw (e.g., shown as t₄ in FIG. 7C) to draw the non-seal edge portions away from the contact surface between the heat seal jaw and the low porosity paper and flexible adhesive combination. For example, the end taper can be from about 5 degrees, 6 degrees, 7 degrees, 8 degrees, 9 degrees, 10 degrees, 11 degrees, 12 degrees, 13 degrees, 14 degrees, 15 degrees, 16 degrees, 17 degrees, 18 degrees, 19 degrees, 20 degrees, 21 degrees, 22 degrees, 23 degrees, 24 degrees, 25 degrees, 26 degrees, 27 degrees, 28 degrees, 29 degrees, 30 degrees, 31 degrees, 32 degrees, 33 degrees, 34 degrees, 35 degrees, 36 degrees, 37 degrees, 38 degrees, 39 degrees, 40 degrees to about 5 degrees, 6 degrees, 7 degrees, 8 degrees, 9 degrees, 10 degrees, 11 degrees, 12 degrees, 13 degrees, 14 degrees, 15 degrees, 16 degrees, 17 degrees, 18 degrees, 19 degrees, 20 degrees, 21 degrees, 22 degrees, 23 degrees, 24 degrees, 25 degrees, 26 degrees, 27 degrees, 28 degrees, 29 degrees, 30 degrees, 31 degrees, 32 degrees, 33 degrees, 34 degrees, 35 degrees, 36 degrees, 37 degrees, 38 degrees, 39 degrees, 40 degrees. In various aspects, the heat seal jaw can include the end taper on each of the opposing ends of the heat seal jaw.

### II. Microwave Popcorn Package Configuration

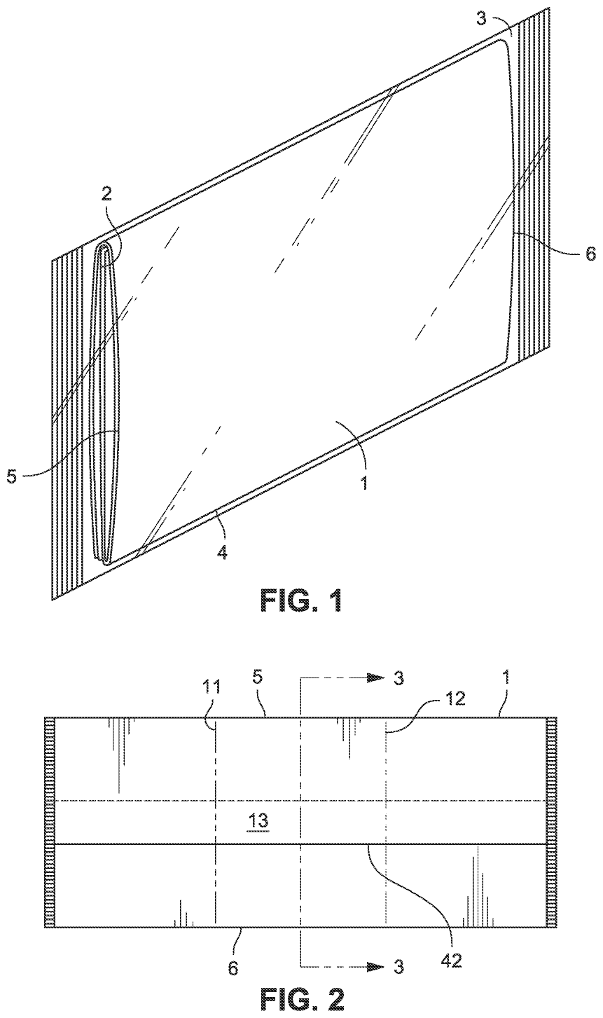

FIG. 1 illustrates a microwaveable popcorn package 1 in accordance with an embodiment of the present disclosure. In FIG. 1, the microwave popcorn package is depicted in a “tri-fold” configuration for storage. The tri-fold 2 can be sealed within a storage overwrap 3. In some embodiments, the storage overwrap 3 is formed from polypropylene, although other materials can be used. The overwrap 3 is meant to be discarded when the microwave popcorn package 1 is removed from storage in preparation for use.

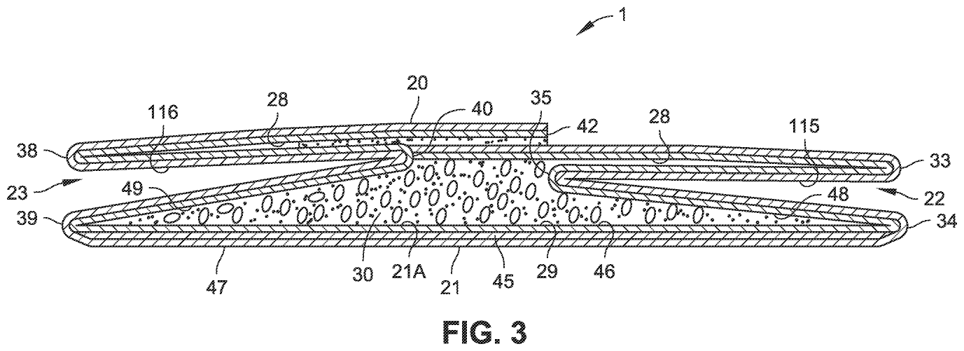

FIG. 2 illustrates a top plan view of bag 1 schematically shown in an unfolded configuration oriented much as it would be when positioned in a microwave oven for popping of an internally received popcorn charge, but before expansion. Lines 11 and 12 indicate fold lines which define a central region 13 and which formed the folds to make the tri-fold 2 of FIG. 1. In central region 13, the unpopped popcorn charge will generally be positioned in an orientation against a portion of the bag 1 in which a microwave interactive construction can be positioned. Herein, in this context, the term “microwave interactive” is meant to refer to a material which absorbs energy and becomes hot, upon exposure to microwave energy in a microwave oven, sometimes referred to as a susceptor.

During the popping operation, moisture inside the popcorn kernels absorbs microwave energy, generating sufficient steam and heat for popping of the kernels and expansion of bag 1. In addition, the microwave interactive material absorbs microwave energy and dissipates heat to the popcorn charge. In some constructions, the microwave interactive material occupies at least central region 13 (internally) and is in greater thermoconductive contact with a portion of that region than any other portions an interior of microwave popcorn package 1. That is, most of the microwave interactive material (by area or weight) is positioned in thermoconductive contact with a region of the bag interior whereat the microwave interactive will be covered by the popping charge (optionally with a ply of the bag therebetween), when the bag 1 is positioned in a microwave oven for use. This can lead to an efficient utilization of microwave interactive material.

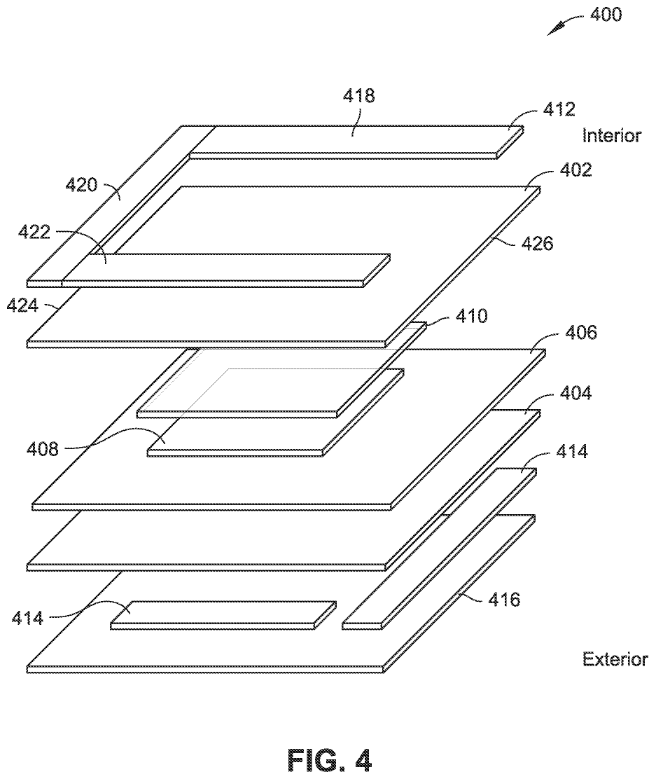

FIG. 3 illustrates a cross-section taken generally along line 3-3 of FIG. 2. The bag 1 generally includes a construction defining first and second opposite face panels 21, 20 joined by first and second side gussets 22, 23. In exemplary embodiments, the opposite face panels can be joined by first and second, opposite, inwardly directed side gussets (e.g., the side gussets 22, 23 point or extend toward one another). In the construction of FIG. 3, the bag 1 is shown having one inwardly directed gusset at each side, however the present disclosure is not limited to single gussets at each side and can include more than one gusset on either or both sides.

The gussets 22, 23 generally separate microwave popcorn package 1 into first and second expandable tubes 28, 29. An unpopped popcorn charge 30 including unpopped popcorn kernels and an oil/fat component is substantially positioned and substantially retained within one of the tubes, in this instance, tube 29. The other tube, tube 28, prior to popping, is generally collapsed. In some embodiments, tube 28 is sealed closed by temporary heat seals prior to the popping operation. The gusset 23 includes a panel section 49 adjacent to, and integral with, face panel 21. Additionally, the gusset 22 includes panel section 48 adjacent to, and integral with, face panel 21. Panel 21 includes region 21a which defines an unpopped popcorn charge retention surface upon which the unpopped popcorn charge 30 is generally positioned in contact with, and generally sitting on, when the bag 1 is positioned in a microwave oven for the popping operation.

The side gusset 22 can be defined by one or more gusset folds. For example, side gusset 22 can include outwardly directed edge creases (e.g., side creases) or folds 33 and 34, with fold 34 being adjacent face panel 21 and fold 33 being adjacent face panel 20; and inwardly directed central fold 35. Similarly, gusset 23 includes outwardly directed edge creases (e.g., side creases) or folds 38 and 39, with fold 39 being adjacent 21 and fold 38 being adjacent 20; and central fold 40. When the bag 1 is folded, a portion of the interior is defined with side creases defined at junctures between the first face panel 21 (e.g., defined by folds 34 and 39), and the first and second opposite, inwardly directed side gussets 22, 23. Side creases can also be defined at junctures between the second face panel 20 (e.g., defined by folds 33 and 38), and the first and second opposite, inwardly directed side gussets 22, 23. In some embodiments, the arrangement shown in FIG. 3 is folded from a two-ply sheet of material, and panel 20 includes central longitudinal seam 42 therein.

Underneath popcorn charge 30, bag 1 can include microwave interactive construction (e.g., susceptor 45). The susceptor 45 can include a flexible, metallized polyester sheet. The susceptor 45 is provided in thermoconductive contact with a popcorn charge retention surface, for example, a portion of the inside of the bag against which the microwave popcorn charge is placed. In some embodiments, such as the one shown in FIG. 3, the susceptor 45 is positioned between layers or plies 46, 47 from which the flexible bag 1 is folded. In some aspects, the ply 46 is the inner ply formed from low porosity paper described herein and the ply 47 is the outer ply formed from low porosity paper described herein. Even with the susceptor 45 positioned between plies 46, 47, the bag 1 is referenced as two-ply. In the arrangement shown, the susceptor 45 only occupies a portion of the area between the plies 46, 47.

In some embodiments, a laminating adhesive may be used between the two plies 46, 47. For example, the laminating adhesive can be the flexible adhesive described herein between the two plies 46, 47 that is continuous and covers the entire area between the plies. In other embodiments, a discontinuous coating may be used for portions of the interface between the two plies 46, 47. In some embodiments, a continuous adhesive may be used at certain locations, and discontinuous adhesive at others. For example, a continuous adhesive can be used at locations at certain locations to provide a greaseproof effect. In an example embodiment, regions for continuous coverage for the lamination adhesive include the regions bounded by inwardly directed gusset folds 40, 35. In specific embodiments, a continuous adhesive can be used as a laminating adhesive in areas of the bag 1 most likely to come into contact with oil/fat during storage, handling or use. For example, a continuous adhesive can be used as a laminating adhesive at locations: (a) within panel 21 on which a popcorn charge will sit in a microwave oven during use; (b) within gusset panels 48, 49 integral with and adjacent panel 21; and/or, (c) within central portions of gusset panels 115, 116 and panel 20.

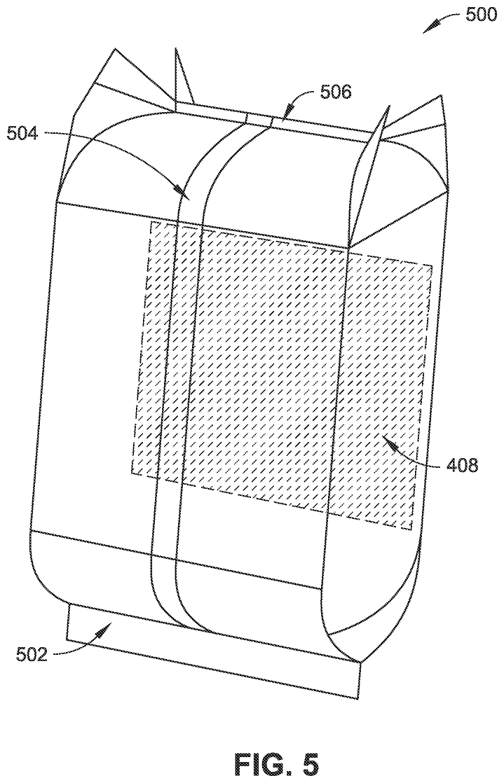

Referring to FIG. 4, a rollstock 400 is shown in exploded view for forming a microwave popcorn package according to example implementations of the present disclosure. The rollstock 400 is shown with the interior portion of the bag 1 shown towards the top and the exterior portion of the bag 1 shown towards the bottom. The rollstock 400 includes an inner ply 402 of low porosity paper (which in aspects corresponds to ply 46) and an outer ply 404 of low porosity paper (which in aspects corresponds to ply 47). The inner ply 402 and the outer ply 404 are laminated together with a laminating adhesive 406, which is shown covering the entire interior surface of the outer ply 404. In various aspects, the laminating adhesive 406 is the flexible adhesive described herein. Alternatively or additionally, the laminating adhesive 406 could cover the entire exterior surface of the inner ply 402.

The rollstock 400 is shown including a susceptor 408 (which in aspects corresponds to susceptor 45) positioned between the inner ply 402 and the outer ply 404 and adhered to the inner ply 402 via a susceptor adhesive 410. Alternatively or additionally, the susceptor 408 could be affixed to the outer ply 404 via an intervening adhesive. The susceptor adhesive 410 can be the same adhesive type as the laminating adhesive 406 or a different adhesive type than the laminating adhesive 406.

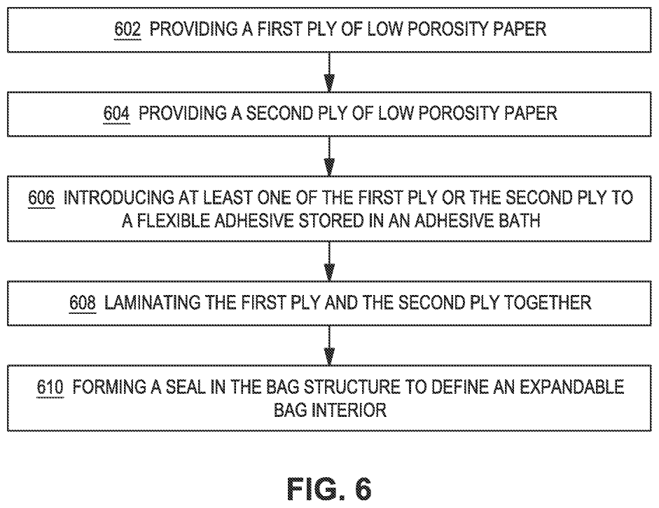

The rollstock 400 also includes adhesive used in the formation of heat seals to form the expandable bag configuration, which is shown in an example collapsed form in FIG. 3 and in an example expanded form 500 in FIG. 5. For example, the rollstock 400 is shown including a heat seal adhesive 412 along three edges of the interior surface of the inner ply 402 which in various aspects can correspond to the bottom end seal 502, the longitudinal seal 504, and the top end seal 506 shown in FIG. 5. The rollstock 400 is also shown including an adhesive 414 on an exterior portion of the outer ply 404 which in various aspects can assist with the adhesive 412 to form the longitudinal seal, gusset seals, or the like. A graphical application 416 can also be applied to the outer ply 404 (e.g., to provide nutrition labels, branding, or other graphics), such as through a graphical printing on the outer ply 404, an adhered label, or combinations thereof.

### III. Microwave Popcorn Package Production Process

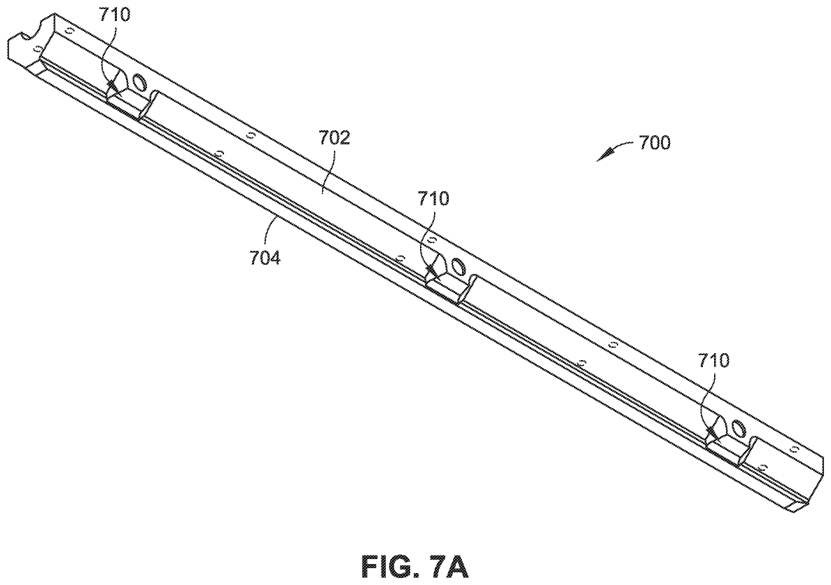

Referring to FIG. 6, a process 600 is shown for producing a microwave popcorn package in accordance with example implementations of the present disclosure. The process 600 includes providing a first ply of low porosity paper in step 602. For example, a feedstock of a paper having a porosity of at least 500,000 Gurley-sec can introduce the first ply to form a portion of a wick resistant two-ply bag structure, however the porosity of the first ply can vary as described herein. The process 600 also includes providing a second ply of low porosity paper in step 604. For example, a feedstock of paper having a porosity of at least 100,000 Gurley-sec can introduce the second ply of the bag structure, however the porosity of the second ply can vary as described herein.

The process 600 further includes introducing at least one of the first ply or the second ply to a flexible adhesive stored in an adhesive bath in step 606. For example, the flexible adhesive can be applied to at least one of an exterior surface of the first ply or an interior surface of the second ply via an adhesive cylinder in contact with the adhesive bath to coat substantially all of at least one of the exterior surface of the inner ply or interior surface of the outer ply with the flexible adhesive. As used herein, a coating that coats or covers “substantially all” of a paper surface refers to a coating applied to at least 90% of the exposed surface area. For example, a coating that coats or covers “substantially all” of a paper surface can refer to a coating applied to at least 90% of the exposed surface area, at least 91% of the exposed surface area, at least 92% of the exposed surface area, at least 93% of the exposed surface area, at least 94% of the exposed surface area, at least 95% of the exposed surface area, at least 96% of the exposed surface area, at least 97% of the exposed surface area, at least 98% of the exposed surface area, at least 99% of the exposed surface area, and 100% of the exposed surface area. By coating substantially all of the surface of at least one of the inner ply or the outer ply, the adhesive can provide a mechanical barrier in combination with the low porosity paper to prevent leakage or wicking of the oil/fat component present in the charge of unpopped popcorn. In implementations, the adhesive used to laminate the inner ply and the outer ply is the same adhesive used to form the heat seal coatings used to form the longitudinal seal, the top seal, and the bottom seal. For example, the heat seal coatings can be provided as a full coverage adhesive to include low modulus adhesive in substantially all regions of the heat seal coating areas. In aspects, the flexible adhesive has a modulus from about 0.5 MPa to about 0.9 MPa, a heat seal temperature from about 200° F. to about 260° F., and a viscosity of less than about 1300 cps at 79° F. with a total solids content of about 52.5%. In some aspects, the adhesive or the adhesive bath includes an anti-foaming agent to prevent gases from being entrained in the adhesive during application to the paper, where entrained gases can form voids that reduce resistance to wicking of the oil/fat component by the paper and adhesive.

During experimentation, the low porosity paper had difficulties pairing with less flexible adhesives, causing fractures at areas of the microwave popcorn package that folded, where the fractures lowered the resistance to leakage or wicking of the oil/fat component. Microwave popcorn packages that merely used traditional adhesives as a lamination agent permitted fracture of the adhesive, since the adhesive was not provided as a mechanical barrier to the oil/fat component, rather, a patterned adhesive inherently provided many gaps in adhesive coverage between two plies of paper. Typically such paper was fluorochemically treated to resist the passage of oil/fat, so the adhesive could fracture and still hold the two plies together. In various aspects, the paper used in the process 600 is substantially free of any fluorocarbon material, such that the flexible adhesive plays an important role in preventing the migration of the oil/fat component through the two-ply bag structure.

The process 600 further includes laminating the first ply and the second ply together in step 608. For example, the first ply and the second ply with the adhesive introduced therebetween can be fed through a roller to press the layers together to laminate the first ply and the second ply with the flexible adhesive. In various aspects, a susceptor can be introduced between the first ply and the second ply prior to lamination to include the susceptor between the first ply and the second ply, such as described with respect to susceptors 45, 408.

The process 600 further includes forming a seal in the bag structure to define an expandable bag interior in step 610. For instance, the adhesive 412 is applied to the interior surface of the inner ply 402 according to heat seal coating regions (e.g., shown in FIGS. 4 as 418, 420, and 422) to facilitate formation of the bottom seal 502, the longitudinal seal 504, and the top seal 506. For example, the rollstock 400 can be folded to bring a first edge 424 in proximity with a second edge 426 to form a tube, wherein the heat seal coating region 420 facilitates formation of the longitudinal seal 504 upon application of heat seal jaws, wherein heat seal coating region 418 facilitates formation of the top seal 506 upon application of heat seal jaws, and wherein heat seal coating region 422 facilitates formation of the bottom seal 502 upon application of heat seal jaws. The tube can be structured with the longitudinal seal 504 formed as a lap seal (e.g., with the heat seal coating region 420 overlapping with an exterior surface of the rollstock 400), as a fin seal (e.g., with the seal coating region 420 overlapping an interior surface of the inner ply 402), or other suitable longitudinal seal structure.

In various aspects, the adhesive 412 is applied to one or more of heat seal coating regions 418, 420, and 422 in a full coverage application that covers substantially all of the heat seal coating region on the inner ply 402. For example, each of the heat seal coating regions 418, 420, and 422 can include a full coverage application of the adhesive 412. The full coverage application of adhesive 412 at the heat seal coating regions can provide increased wicking resistance at the seals as compared to a patterned application of adhesive (i.e., a non-full coverage application). In various aspects, the process 600 includes forming a longitudinal seal having a width from about 0.30 in to about 0.45 in to promote heal sealing of the flexible adhesive and low porosity paper while preventing substantial blistering between the paper and the adhesive. During experimentation, traditional heat seal jaws using traditional adhesives required heat seal temperatures greater than about 300° F. to seal, however the low porosity paper resisted water vapor diffusion through the paper more than higher porosity paper traditionally used with fluorochemical treatments. The higher temperatures used for higher porosity paper caused moisture to flash in lower porosity paper, where the lower porosity paper could not diffuse as much moisture away from the paper, resulting in blistering of the adhesive and paper, leaving voids or other areas having reduced resistance to leakage or wicking of the oil/fat component. Further, the traditional heat seal jaws positioned non-sealing edges in close proximity to the paper, increasing the amount of heat transferred to the paper, resulting in additional blistering.

In various aspects, the heat seal jaw used to form the longitudinal seal in the process 600 have a narrower width and a steeper angled taper than traditional jaw designs to provide sufficient seal strength to maintain the integrity of the collapsible bag seals during the microwave popping operation and to keep non-seal edge portions of the heat seal jaw away from the paper and adhesive to avoid substantial moisture flashing that could introduce bubbles or voids in the adhesive, particularly with the full-coverage flexible adhesive. For example, FIGS. 7A through 7C show an example heat seal jaw 700 used in the process 600. The heat seal jaw 700 includes a body portion 702 and a seal portion 704 at a bottom surface of the body portion 702. The body portion 702 can couple with heat sources which transfer heat through to the seal portion 704 to interact with the low porosity paper and flexible adhesive. The seal portion 704 is shown having a first taper (t₁) from about 50 degrees to about 70 degrees from the horizontal extending from a first side 706 and a second side 708 of the heat seal jaw 700. The first taper is substantially steep to draw non-seal edge portions of the heat seal jaw (e.g., the body portion 702) away from the paper and adhesive to avoid substantial moisture flashing that could introduce bubbles or voids in the adhesive. In implementations, the seal portion 704 includes a cross-sectional width (e.g., shown as w₁ in FIG. 7B) that is from about 15% to about 35% of a cross-sectional width (e.g., shown as w₂ in FIG. 7B) of the body portion 702 to keep non-contact portions of the heat seal body portion 702 away from the contact interface between the seal portion 704 and the paper and adhesive of the microwave popcorn package.

The heat seal jaw 700 is also shown with the body portion 702 transitioning from the first taper to a second taper (t₂) on each of the first side 706 and the second side 708, with the second taper being shallower than the first taper. For example, the second taper can be from about 40 degrees to about 50 degrees from the horizontal. The first side 706 is also shown with a portion of the body portion 702 transitioning from the first taper to a third taper (t₃) from about 5 degrees to about 35 degrees (e.g., shown in FIGS. 7A and 7B as 710). Referring to FIG. 7C, the heat seal jaw 700 is shown with an end taper (t₄) extending in the longitudinal direction of the heat seal jaw 700 having a taper from about 5 degrees to about 40 degrees from the horizontal to draw the non-seal edge portions away from the contact surface between the heat seal jaw 700 and the low porosity paper and flexible adhesive combination.

In embodiments, the oil/fat component used in the charge of unpopped popcorn kernels can include at least 80 wt-% of the oil/fat material and is present in a level of at least 8 wt-% of the unpopped popcorn kernels. In a specific embodiment, the first oil/fat component includes at least 99 wt-% of the oil/fat material and is present at a level of at least 20 wt-% of the unpopped popcorn kernels.

In embodiments, the oil component used can include any glyceride with at least one fatty acid, and/or one or more liquid oils such as a liquid vegetable oil. In one aspect, the oil component can include a liquid vegetable such as soybean oil, canola oil, sunflower oil, corn oil, grapeseed oil, cottonseed oil, mid-oleic sunflower oil, safflower oil, palm oil, coconut oil, partially hydrogenated oils of these oils, mixtures thereof, and so forth. In other aspects, the oil/fat component can include an intersterified blend of an oil component and a stearine component. The oil component used in the intersterified blend can include any of the oil components described above. The stearine component used in the interesterified blend can include, but is not necessarily limited to: cottonseed stearine, soybean stearine, mixtures thereof, and so forth.

In some instances, the first oil/fat component includes a mixture of the interesterified blend and a second stearine component. When this is done, the mixture can contain at least 2 wt-% of the second stearine component. The second stearine component can include, but is not necessarily limited to: cottonseed stearine, soybean stearine, corn stearine, palm stearine, mixtures thereof, and so forth. The second stearine component can be selected independently of the first stearine component.

In aspects where a “zero trans” or “no trans” oil is desired, palm oil may be suitable as a “zero trans” or “no trans” oil, with the embodiments described herein. Other low trans oils, such as those having a Mettler drop point of no greater than 130° F. can also be used.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A heat seal jaw for forming a heat seal in a microwave popcorn package, comprising:
a heat seal body portion extending longitudinally between opposing first and second ends, the heat seal body portion defining a first side extending between the first end and the second end and defining a second side extending between the first end and the second end opposite the first side; and
a seal portion extending and tapering from the heat seal body portion, the seal portion defining a first tapered portion on the first side and a second tapered portion on the second side, wherein each of the first tapered portion and the second tapered portion includes a taper from about 50 degrees to about 70 degrees from a horizontal extending from the first side to the second side to keep non-seal edge portions of the heat seal jaw away from paper and adhesive of the microwave popcorn package to avoid substantial moisture flashing that could introduce bubbles or voids in the adhesive.

2. The heat seal jaw of claim 1, wherein the first tapered portion transitions from the taper to a second taper.

3. The heat seal jaw of claim 2, wherein the second taper is from about 40 degrees to about 50 degrees from the horizontal.

4. The heat seal jaw of claim 3, wherein the second tapered portion transitions from the first taper to a third taper.

5. The heat seal jaw of claim 4, wherein the third taper is from about 40 degrees to about 50 degrees from the horizontal.

6. The heat seal jaw of claim 5, wherein the seal portion defines a third tapered portion on the first side longitudinally displaced from the first tapered portion, and wherein the third tapered portion transitions from a fourth taper of about 50 degrees to about 70 degrees to a fifth taper of about 5 degrees to about 35 degrees.

7. The heat seal jaw of claim 1, wherein the seal portion defines a third tapered portion on the first side longitudinally displaced from the first tapered portion, and wherein the third tapered portion transitions from a second taper of about 50 degrees to about 70 degrees to a third taper of about 5 degrees to about 35 degrees.

8. The heat seal jaw of claim 1, wherein a cross-sectional width of the seal portion configured to contact the microwave popcorn package is from about 15% to about 35% of a cross-sectional width of the body portion.

9. The heat seal jaw of claim 1, wherein a cross-sectional width of the seal portion is from about 0.30 in to about 0.45 in.

10. The heat seal jaw of claim 1, wherein the seal portion defines a longitudinal end taper at one or both of the first end and the second end.

11. The heat seal jaw of claim 10, wherein the longitudinal end taper is from about 5 degrees to about 40 degrees from a horizontal extending from the first end to the second end.

12. A process for forming a microwave popcorn package from substantially entirely non-fluorocarbon material, comprising
providing a first feed of paper as a first ply of a wick resistant two-ply bag structure, the first ply having a porosity of at least 50,000 Gurley-sec;
providing a second feed of paper as a second ply of the bag structure, the second ply having a porosity of at least 50,000 Gurley-sec;
introducing a flexible adhesive to at least one of the first ply or the second ply to coat substantially all at least one of an exterior surface of the first ply or an interior surface of the second ply with the flexible adhesive;
introducing the flexible adhesive as a heat seal coating on an interior surface of the first ply in a plurality heat seal coating regions with the adhesive covering substantially all of the heat seal coating regions,
laminating the first ply and the second ply together to provide a laminated paper; and
forming a longitudinal seal in the bag structure with a heal seal jaw in contact with the laminated paper to define an expandable bag interior, the heat seal jaw including
a heat seal body portion extending longitudinally between opposing first and second ends, the heat seal body portion defining a first side extending between the first end and the second end and defining a second side extending between the first end and the second end opposite the first side; and
a seal portion extending and tapering from the heat seal body portion, the seal portion defining a first tapered portion on the first side and a second tapered portion on the second side, wherein each of the first tapered portion and the second tapered portion includes a taper from about 50 degrees to about 70 degrees from a horizontal extending from the first side to the second side to keep non-seal edge portions of the heat seal jaw away from paper and adhesive of the microwave popcorn package to avoid substantial moisture flashing that could introduce bubbles or voids in the adhesive.

13. The process of claim 12, wherein the first tapered portion transitions from the taper to a second taper that is from about 40 degrees to about 50 degrees from the horizontal.

14. The process of claim 13, wherein the second tapered portion transitions from the first taper to a third taper.

15. The process of claim 14, wherein the third taper is from about 40 degrees to about 50 degrees from the horizontal.

16. The process of claim 15, wherein the seal portion defines a third tapered portion on the first side longitudinally displaced from the first tapered portion, and wherein the third tapered portion transitions from a fourth taper of about 50 degrees to about 70 degrees to a fifth taper of about 5 degrees to about 35 degrees.

17. The process of claim 12, wherein the seal portion defines a third tapered portion on the first side longitudinally displaced from the first tapered portion, and wherein the third tapered portion transitions from a second taper of about 50 degrees to about 70 degrees to a third taper of about 5 degrees to about 35 degrees.

18. The process of claim 12, wherein a cross-sectional width of the seal portion configured to contact the microwave popcorn package is from about 15% to about 35% of a cross-sectional width of the body portion.

19. The process of claim 12, wherein a cross-sectional width of the seal portion is from about 0.30 in to about 0.45 in.

20. The process of claim 12, wherein the seal portion defines a longitudinal end taper at one or both of the first end and the second end, and wherein the longitudinal end taper is from about 5 degrees to about 40 degrees from a horizontal extending from the first end to the second end.
